(19) United States
(12) Patent Application Publication
(10) Pub. No.: US 2016/0127292 A1
(43) Pub. Date: May 5, 2016

(54) METHOD AND SYSTEM FOR CONTROLLING POLLING IN MESSAGE CONVERSATIONS ACROSS MULTIPLE DEVICES

(71) Applicant: VONAGE NETWORK LLC, Holmdel, NJ (US)

(72) Inventors: Eli Birger, Petah Tikva (IL); Erez Nahum, Tel-Aviv (IL)

(21) Appl. No.: 14/528,335

(22) Filed: Oct. 30, 2014

(51) Int. Cl. H04L 12/58; H04W 4/14

(52) U.S. Cl. CPC H04L 51/16; H04L 51/04; H04W 4/14

(57) ABSTRACT

A method and apparatus for controlling polling in message conversations across multiple devices are provided herein. The method includes displaying a poll in a messaging conversation display screen on a first participant device, wherein the poll comprises at least two polling options; receiving an instruction to update the poll based on a response to the poll from at least one of the multiple devices; and updating the poll per the received instruction.

### BACKGROUND

1. Field

Embodiments of the present invention generally relate to methods and systems for group chat messages, and more particularly, to a method and system for controlling polling in message conversations in messaging applications across multiple devices.

2. Description of the Related Art

A mobile phone user often communicates with one or more other mobile phone users via mobile messaging. Mobile messaging includes, but is not limited to, Short Message Service (SMS) communication services, multimedia messaging service (MMS) communication services, instant messaging, over the top (OTT) chats, and the like. Mobile messaging between two users forms a text message conversation. Mobile messaging enables the exchange of multimedia content, e.g., text, images, videos, and other multimedia objects, in messages sent between mobile devices. Mobile messaging also facilitates group conversations, or multiple-recipient messaging. In group messaging conversations, a message can be sent, or broadcast, to more than one addressee. When an addressee responds, or replies, to the message, the response is broadcast to all addressees/recipients of the message.

Mobile messages are generally referred to as messages herein. Messages on a display of each mobile phone scroll as a conversation progresses. Message scrolling makes room in the display for incoming messages. A user in a group messaging conversation may wish to poll other members of the group to gather information. For example, a user may wish to propose a number of restaurants to members of a group messaging conversation in order to determine where the members would like to meet for dinner. Currently, text messages responses are displayed, but scroll off the display in order to make room for incoming messages. Message responses include members of the group expressing options, such as a selection of one of the proposed choices, or a proposal for an additional choice to be added to the poll. The current method of polling by tracking responses on a scrolling display is tedious and inefficient.

Therefore there exists a need in the art for a method and system for controlling polling in message conversations in messaging applications across multiple devices.

### SUMMARY

A method and system for controlling polling in message conversations in messaging applications across multiple devices are provided herein. In some embodiments, a method for controlling polling in message conversations in messaging applications across multiple devices may include displaying a poll in a messaging conversation display screen on a first participant device, wherein the poll comprises at least two polling options; receiving an instruction to update the poll based on a response to the poll from at least one of the multiple devices; and updating the poll per the received instruction.

In some embodiments, a system for controlling polling in message conversations in messaging applications across multiple devices may include a messaging application comprising a polling module configured to display a poll in a messaging conversation display screen on a first participant device, wherein the poll comprises at least two polling options; receive an instruction to update the poll based on a response to the poll from at least one of the multiple devices; and update the poll per the received instruction.

In some embodiments, a computer readable medium for anchoring and controlling objects in messages across multiple devices is disclosed. The computer readable medium comprises instructions that when executed by at least one processor causes the at least one processor to perform the method controlling polling in message conversations in messaging applications across multiple devices.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 depicts a block diagram of a telecommunication network, according to one or more embodiments of the invention;

FIGS. 2A-2D depict a graphical user interfaces for controlling polling in message conversations in messaging applications across multiple devices, according to one or more embodiments;

FIG. 3 depicts a block diagram of a system for controlling polling in message conversations in messaging applications across multiple devices, according to one or more embodiments;

FIG. 4 depicts a flow diagram of a method for controlling polling in message conversations in messaging applications across multiple devices, according to one or more embodiments of the invention; and

FIG. 5 depicts a computer system that can be utilized in various embodiments of the present invention to implement the computer and/or the display, according to one or more embodiments.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

Embodiments of the present invention generally relate to a method and apparatus for embodiments, a system for controlling polling in message conversations in messaging applications across multiple devices. More specifically, embodiments of the present invention enable fixing the position of a poll message in messaging displays of two or more participants in a messaging conversation. In some embodiments, sending a poll in a messaging conversation is facilitated with a new message type, e.g., a VOTE message type. In some embodiments, a VOTE message type (e.g., a vote message) may be transmitted via SMS or MMS to send polls in a messaging conversation.

In some embodiments, the poll includes two or more polling options and an expiration time. For participants in the messaging conversation, the poll may be fixed in a non-scrollable area of the messaging displays of the participants' devices in some embodiments, while incoming text messages continue to scroll in a scrollable area of the messaging displays. Embodiments of the present invention allow the participants of the message conversation to modify, or otherwise interact with, the poll; for example by adding a polling option or voting for an existing polling option. When a vote is submitted, the vote is added to a tally of votes for the polling option. The updated vote tally and/or added polling options are mirrored in the messaging windows of all participants in the message conversation. Participants may add polling options, vote, and/or change their votes until the time when the poll expires. Once the expiration time is reached, the final vote tallies are displayed to all participants in the message conversation. The results of the poll may then be shared on social media websites.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Some exemplary embodiments described below are with respect to a mobile Voice over Internet Protocol (VOIP) telecommunication app. However, one skilled in the art will readily recognize from the following description that any native application may be used in embodiments consistent with the present invention without departing from the principles of the disclosure described herein.

In the following description, the terms VOIP system, VOIP telephony system, IP system and IP telephony system are all intended to refer to a system that connects callers and that delivers data, text and video communications using Internet protocol data communications. Those of ordinary skill in the art will recognize that embodiments of the present invention are not limited to use with IP telephony systems and may also be used in other systems.

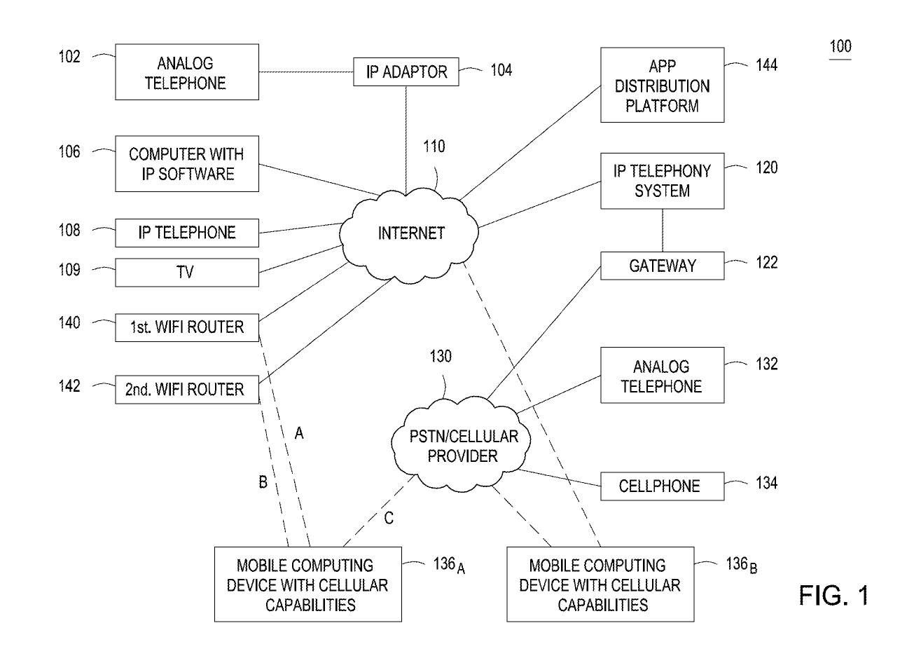

As illustrated in FIG. 1, a communications environment 100 is provided to facilitate IP enhanced communications. An IP telephony system 120 enables connection of telephone calls between its own customers and other parties via data communications that pass over a data network 110. The data network 110 is commonly the Internet, although the IP telephony system 120 may also make use of private data networks. The IP telephony system 120 is connected to the Internet 110. In addition, the IP telephony system 120 is connected to a publicly switched telephone network (PSTN) 130 via a gateway 122. The PSTN 130 may also be directly coupled to the Internet 110 through one of its own internal gateways (not shown). Thus, communications may pass back and forth between the IP telephony system 120 and the PSTN 130 through the Internet 110 via a gateway maintained within the PSTN 130.

The gateway 122 allows users and devices that are connected to the PSTN 130 to connect with users and devices that are reachable through the IP telephony system 120, and vice versa. In some instances, the gateway 122 would be a part of the IP telephony system 120. In other instances, the gateway 122 could be maintained by a third party.

Customers of the IP telephony system 120 can place and receive telephone calls using an IP telephone 108 that is connected to the Internet 110. Such an IP telephone 108 could be connected to an Internet service provider via a wired connection or via a wireless router. In some instances, the IP telephone 108 could utilize a packet-switched network of a cellular telephone system to access the Internet 110.

Alternatively, a customer could utilize an analog telephone 102 which is connected to the Internet 110 via a telephone adapter 104. The telephone adapter 104 converts analog signals from the telephone 102 into data signals that pass over the Internet 110, and vice versa. Analog telephone devices include but are not limited to standard telephones and document imaging devices such as facsimile machines. A configuration using a telephone adapter 104 is common where the analog telephone 102 is located in a residence or business. Other configurations are also possible where multiple analog telephones share access through the same IP adaptor. In those situations, all analog telephones could share the same telephone number, or multiple communication lines (e.g., additional telephone numbers) may provisioned by the IP telephony system 120.

In addition, a customer could utilize a soft-phone client running on a computer 106 or a television 109 to place and receive IP based telephone calls, and to access other IP telephony systems (not shown). The computer 106 may be a personal computer (PC), a tablet device, a gaming system, and the like. In some instances, the soft-phone client could be assigned its own telephone number. In other instances, the soft-phone client could be associated with a telephone number that is also assigned to an IP telephone 108, or to a telephone adaptor 104 that is connected to one or more analog telephones 102.

Users of the IP telephony system 120 are able to access the service from virtually any location where they can connect to the Internet 110. Thus, a customer could register with an IP telephony system provider in the U.S., and that customer could then use an IP telephone 108 located in a country outside the U.S. to access the services. Likewise, the customer could also utilize a computer outside the U.S. that is running a soft-phone client to access the IP telephony system 120.

A third party using an analog telephone 132 which is connected to the PSTN 130 may call a customer of the IP telephony system 120. In this instance, the call is initially connected from the analog telephone 132 to the PSTN 130, and then from the PSTN 130, through the gateway 122 to the IP telephony system 120. The IP telephony system 120 then routes the call to the customer's IP telephony device. A third party using a cellular telephone 134 could also place a call to an IP telephony system customer, and the connection would be established in a similar manner, although the first link would involve communications between the cellular telephone 134 and a cellular telephone network. For purposes of this explanation, the cellular telephone network is considered part of the PSTN 130.

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone that can facilitate voice based session calls, and an IP telephone that can facilitate data based session calls.

The following description will also refer to a mobile telephony device. The term “mobile telephony device” is intended to encompass multiple different types of devices. In some instances, a mobile telephony device could be a cellular telephone. In other instances, a mobile telephony device may be a mobile computing device, such as the APPLE IPHONE, that includes both cellular telephone capabilities and a wireless data transceiver that can establish a wireless data connection to a data network. Such a mobile computing device could run appropriate application software to conduct VoIP telephone calls via a wireless data connection. Thus, a mobile computing device, such as an APPLE IPHONE, a RIM BLACKBERRY or a comparable device running GOOGLE ANDROID operating system could be a mobile telephony device.

In still other instances, a mobile telephony device may be a device that is not traditionally used as a telephony device, but which includes a wireless data transceiver that can establish a wireless data connection to a data network. Examples of such devices include the APPLE IPOD TOUCH and the IPAD. Such a device may act as a mobile telephony device once it is configured with appropriate application software.

FIG. 1 illustrates that a mobile computing device with cellular capabilities 136_{A} (e.g., a smartphone) is capable of establishing a first wireless data connection A with a first wireless access point 140, such as a wireless local area network (WLAN) based on the Institute of Electrical and Electronics Engineers' (IEEE) 802.11 and 802.13 standards router. The first wireless access point 140 is coupled to the Internet 110. Thus, the mobile computing device 136_{A} can establish a VOIP telephone call with the IP telephony system 120 via a path through the Internet 110 and the first wireless access point 140.

FIG. 1 also illustrates that the mobile computing device 136_{A} can establish a second wireless data connection B with a second wireless access point 142 that is also coupled to the Internet 110. Further, the mobile computing device 136_{A} can establish either a third wireless data connection C via a packet-switch network provided by a cellular service provider 130 using its cellular telephone capabilities, or establish a voice based session telephone call via a circuit-switched network provided by a cellular service provider 130. The mobile computing device 136_{A} could also establish a VoIP telephone call with the IP telephony system 120 via the second wireless connection B or the third wireless connection C.

Although not illustrated in FIG. 1, the mobile computing device 136_{A} may be capable of establishing a wireless data connection to a data network, such as the Internet 110, via alternate means. For example, the mobile computing device 136_{A} might link to some other type of wireless interface using an alternate communication protocol, such as the wireless local area network (WLAN) based on the Institute of Electrical and Electronics Engineers' (IEEE) 802.11 and 802.13 standards.

Similarly, mobile computing device with cellular capabilities 136_{B} may also be coupled to internet 110 and/or cellular service provider 130. In some embodiments, mobile computing device 136_{B} may be connected to internet 110 via a wireless local area network (WLAN) based on the Institute of Electrical and Electronics Engineers' (IEEE) 802.11 and 802.13 standards connection, and the like, and can also establish a VOIP telephone call with the IP telephony system 120 similar to mobile computing device 136_{A}. In embodiments of the present invention, communications environment 100 may be used to establish voice based or data based telecommunications sessions between mobile computing device 136_{A} and mobile computing device 136_{B}, depending on various criteria associated with each of the mobile computing devices, as will be described below in more detail.

In the embodiments described above, a device may act as a mobile telephony device once it is configured with appropriate application software that may be downloaded from an app distribution platform 144. For example, mobile computing device 136_{A} may download a VOIP mobile app from app distribution platform 144 and install the VOIP mobile app locally making the app a native application running on mobile computing device 136_{A}.

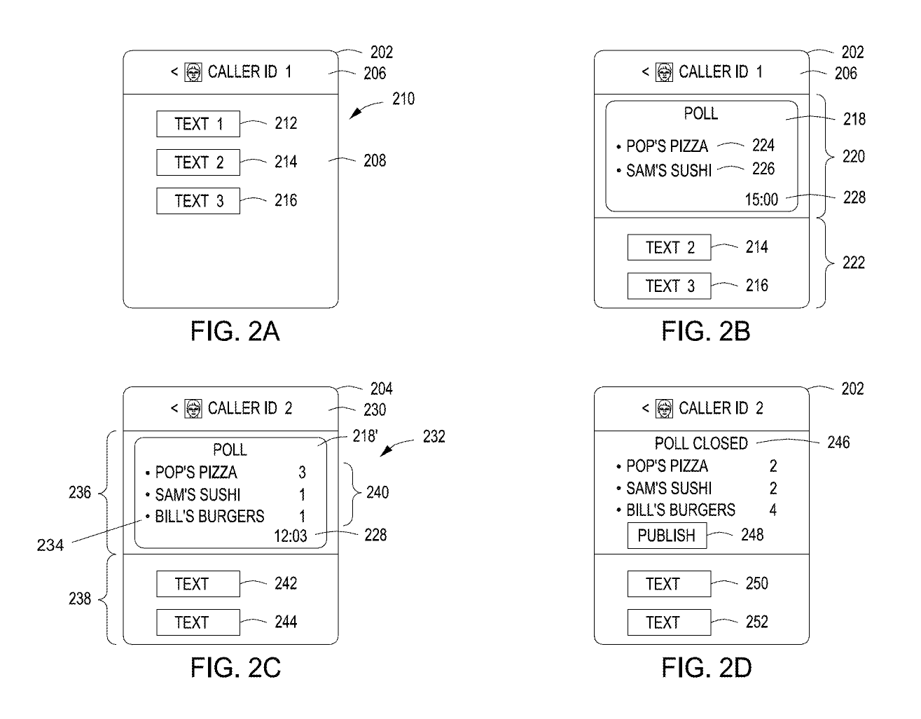

FIGS. 2A-2D illustrate graphical user interfaces for controlling polling in message conversations in messaging applications across multiple devices, according to one or more embodiments. In some embodiments, as shown in FIG. 2A-2D, user devices 202, 204 (such as, for example, mobile computing devices 136_{A}, 136_{B}) may exchange messages in an SMS or MMS messaging conversation via messaging applications installed on each device. A user may create a poll in a group messaging conversation. The poll may be created in the form a Vote message type, which may be sent using SMS, MMS that will be displayed on the user devices 202, 204 of other participants in the group messaging conversation. The poll may include two or more options on which to vote and an expiration time for voting. In addition, the ability to add polling options to the poll may be enabled. The participants' vote tallies are displayed with the poll in a polling pane on each user device 202, 204.

FIG. 2A depicts user device 202 that includes a display 206. The display 206 of the user device 202 displays a messaging pane 208 of a messaging application 210. In some embodiments, the message application 210 may be a standalone over-the-top (OTT) application installed on device 202, or a feature/module of an OTT telecommunication app that supports messaging (e.g., a VoIP mobile telecommunication app). The messaging pane 208 includes text messages 212, 214, 216. As the conversation progresses, the text messages 212, 214, 216 scroll off the screen in order to make room in the messaging pane 208 for new messages.

FIG. 2B depicts user device 202 after a poll 218 has been created for participants of a group messaging conversation. In embodiments consistent with the present invention, a user of user device 202 creates a poll 218 in the messaging pane 208 to be anchored to a location within messaging pane 208 on the display 206 of user device 202 such that poll 218 remains visible and does not scroll as new messages are sent and/or received (i.e., the location of poll 218 is fixed to a non-scrollable portion or pane 220 of the messaging pane 208). In some embodiments, the size and position of non-scrollable fixed poll pane 220 area may be defined (e.g., by default and/or set by the user). In some embodiments, the poll 218 is automatically positioned (e.g., centered) and/or adjusted to a size/shape such that it may fit within the non-scrollable fixed poll pane 220. When the location of poll 218 is fixed on the display 206 of device 202, a corresponding poll location is also fixed within the messaging pane on the display 230 of user device 204. In some embodiments, the position to which the poll 218 is anchored/fixed to may be configurable by the user. All new messages sent and received would continue to scroll in a reduced scrollable message pane 222.

In some embodiments, when the poll 218 is anchored to a position within messaging pane 208 as described above, a poll instruction message (e.g., a vote message) is generated by messaging application 210 that includes the poll 218, or information associated with the poll 218, for example the polling options and an expiration timer, and instructions to anchor the poll 218, within a fixed poll pane 220 of messaging application 210 on the display 206. In some embodiments, the polling options include a hyperlink that, when selected, navigates a participant to more information about the polling option.

The poll instruction message is transmitted by messaging application 210 via a network to a service provider's server, which in turn, forwards the poll instruction message to the user device 204. It is generally understood in the art that forwarding a message, for example, may include generating and sending a new message based on the received message and not literally forwarding the exact message received. In some embodiments, the poll instruction message may be an SMS or MMS message with customized header information that includes the poll instructions. In some embodiments, the poll instruction message may be of a new message type, such as a vote message, as described above. The poll instruction message may include, but is not limited to information such as a group identifier, group members, a creation timestamp, and expiration timestamp, a last update timestamp, an initiator identifier, a reply status per group member, an overall status, vote content, as well as service data including hyperlinks. In some embodiments, the poll instruction message may use a proprietary messaging protocol, such as a Session Initiation Protocol (SIP) message, or use a standard protocol, such as an Extensible Messaging and Presence Protocol (XMPP) message. If the conversation is a group conversation that includes more than two participants, the message is transmitted to user device(s) of each of the participants in the conversation.

As an example, the poll 218 provides restaurant choices such that participants in the group messaging conversation may vote on where to go for dinner. The poll 218 includes polling options 224, 226 and an expiration timer 228 that indicates how much time is remaining for the participants in the group messaging conversation to cast a vote in the poll 218. In the present example, the polling options 224, 226 are restaurant choices “Pop's Pizza” and “Sam's Sushi”. Based on the expiration timer 228, the participants have 15 minutes to respond to the poll. In some embodiments, selecting the poll 218 causes a selectable menu option to be displayed. For example, when a user presses poll 218, an “add polling option” or “vote” menu item/icon may be displayed on device 202. When the “add polling option” menu item/icon is selected, a user may enter a new polling option. Alternatively, a user may select one of the polling options 224, 226 and submit a vote. Upon submission of a vote or the addition of the added polling option, a poll instruction message is sent to a service provider's server indicating the participant's response. If the response is a vote, the vote is recorded at the service provider's server and the new vote tallies are forwarded to the user devices of all participants in the message conversation. If the response is an added polling option, the new polling option is added to the polling options and the updated polling options and vote tallies are forwarded for display on each user device.

FIG. 2C depicts the display 230 of user device 204 after the poll 218′ is fixed on the display 230. The user device 204 includes a messaging application 232 that receives the poll instruction message. The messaging application 232 parses the poll instruction message and anchors the poll accordingly. The poll 218′ on device 204 is the corresponding poll 218 on device 202. The user device 204 includes a fixed poll pane 236 and a reduced messaging pane 238. In some embodiments, the fixed poll 218′ is centered in the fixed poll pane 236. In the reduced messaging pane 238, additional messages (e.g., text 242, 244) scroll to make room in the reduced message pane 238 for incoming/outgoing messages. As incoming messages arrive and outgoing messages are sent, the fixed poll 218′ in the fixed poll pane 236 remains in view. As the participants continue to text commentary regarding the poll, the poll 218/218′ remains in view while other messages continue to scroll in the reduced messaging panes 222, 238.

A participant may respond to the poll 218/218′ by performing an action. In one example, the participant of user device 204 selects the fixed poll 218′ and selects to “add a polling option”. The participant may then enter a new polling option. When the participant submits the polling option, a polling instruction message is transmitted by a poll control module (discussed in greater detail below) via a network to a service provider's server. At the service provider's server, the new polling option is added to the poll, and the polling instruction message is forwarded to all participants of the group messaging conversation instructing a polling module (discussed in greater detail below) to add the new polling option to the poll 218/218′. In another example, the participant of user device 204 selects the poll 218′. The participant presses and slides the participant's finger across a polling option 224, 226, 234, causing a vote to be cast. When a vote is cast, an instruction message is transmitted to the service provider server indicating the vote. The vote is recorded at the service provider's server and an instruction message including the updated poll with tallied votes is sent to all participants in the group messaging conversation. As such, the votes are tallied in real-time.

As shown in FIG. 2C, a number of responses to the poll have been received. The original poll 218 options 224, 226 remain, however a user has added a third polling option 234 to the poll, specifically “Bill's Burgers”. Votes 240 have been tallied at the service provider's server for the polling options 224, 226, 234 based on responses received from participants in the group messaging conversation. The expiration timer 228 indicates the time remaining to respond to the poll. During the remaining time, users may change their votes and/or continue to add polling options. Texts 242, 244 continue to be displayed in the scrollable area of the display.

FIG. 2D depicts user device 202 after the time to respond to the poll has expired. When the time to respond to the poll 218 expires, the service provider's service transmits a message that the polling is closed. In some embodiments, the message includes a final vote tally for each polling option. An indicator 246 displays that the poll has closed. Optionally, for example, a button 248 or other icon is displayed that allows a participant to share the results of the poll 218, for example on a social media website. In the present example, eight participants voted on three locations for dinner. Bill's Burgers received the most votes. A participant may share the selected location so others may join, whether for a meeting or social event. Using the APIs of the various social media websites, a new post may be created and within the post the vote results are displayed with an invitation to join an event. Alternatively, the APIs may be used to create an event on the social networking site.

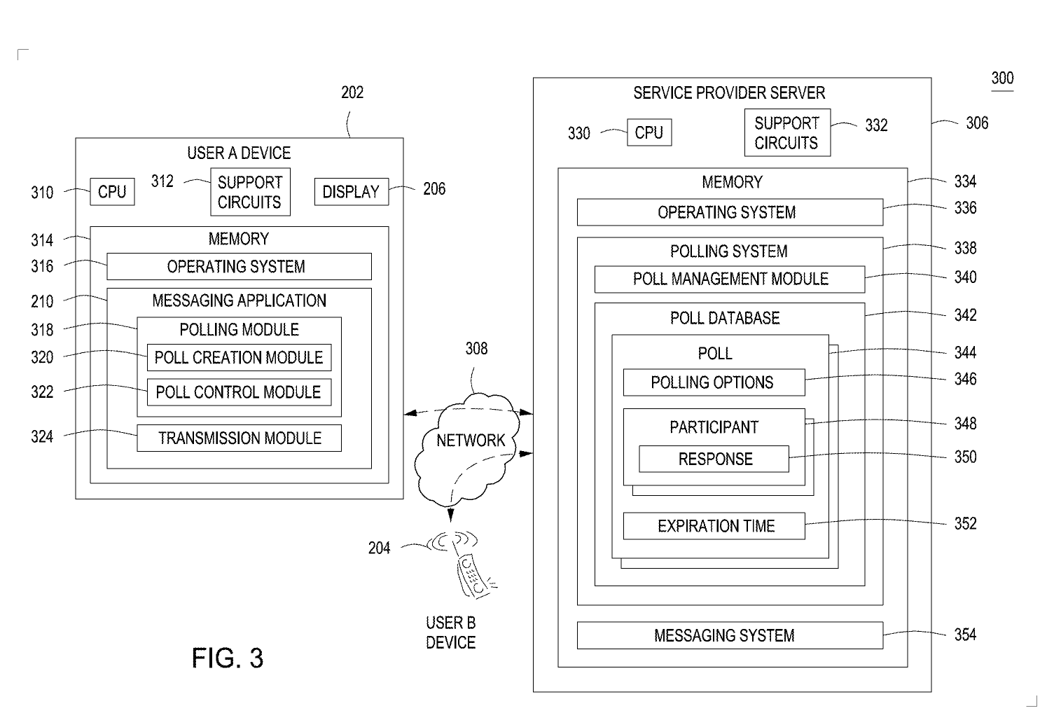

FIG. 3 depicts a block diagram of a system 300 for controlling polling in message conversations in messaging applications across multiple devices, according to one or more embodiments. The system 300 includes at least one telecommunication service provider server 306 that can provide telecommunication services to a plurality of end-user devices (e.g., such as User A device 202 and User B device 204) via one or more networks 308. Devices 202 and 204 may include a computer with IP software 106, IP telephone 108, and/or mobile computing device with cellular capabilities 136A, 136B, and the like, as shown in FIG. 1. The telecommunication service provider server 306 may include IP telephone system 120 or PSTN/cellular provider 130.

Each user device (e.g., User A device 202 and User B device 204) comprises a Central Processing Unit (CPU) 310, support circuits 312, display 206, and a memory 314. The CPU 310 may comprise one or more commercially available microprocessors or microcontrollers that facilitate data processing and storage. The various support circuits 312 facilitate the operation of the CPU 310 and include one or more clock circuits, power supplies, cache, input/output circuits, and the like. The memory 314 comprises at least one of Read Only Memory (ROM), Random Access Memory (RAM), disk drive storage, optical storage, removable storage and/or the like. In some embodiments, the memory 314 comprises an operating system 316 and a messaging application 210. The messaging application 210 may include a polling module 318 and a transmission module 324. In some embodiments, the messaging application 210 may be an OTT telecommunication application as described above. The polling module 328 may include a poll creation module 320 and a poll control module 322.

The operating system (OS) 316 generally manages various computer resources (e.g., network resources, file processors, and/or the like). The operating system 316 is configured to execute operations on one or more hardware and/or software modules, such as Network Interface Cards (NICs), hard disks, virtualization layers, firewalls and/or the like. Examples of the operating system 316 may include, but are not limited to, LINUX, MAC OSX, BSD, UNIX, MICROSOFT WINDOWS, IOS, ANDROID and the like.

The telecommunication service provider server 306 may include a Central Processing Unit (CPU) 330, support circuits 332, and memory 334. The CPU 330 may comprise one or more commercially available microprocessors or microcontrollers that facilitate data processing and storage. The various support circuits 332 facilitate the operation of the CPU 330 and include one or more clock circuits, power supplies, cache, input/output circuits, and the like. The memory 334 comprises at least one of Read Only Memory (ROM), Random Access Memory (RAM), disk drive storage, optical storage, removable storage and/or the like. The memory 334 includes an operating system 336, a polling system 338, and a messaging system 354. The messaging system 354 may be any system that facilitates the sending and receiving of SMS and MMS message, OTT messaging app messages, and the like. The polling system 338 may include a poll management module 340 and a poll database 342. The poll database 342 includes for each poll 344, polling options 346, participant information 348, and an expiration time 352 for the poll 344. The participant information 348 includes the participant's response 350 to the poll.

The operating system 336 generally manages various computer resources (e.g., network resources, file processors, and/or the like). The operating system 336 is configured to execute operations on one or more hardware and/or software modules, such as Network Interface Cards (NICs), hard disks, virtualization layers, firewalls and/or the like. Examples of the operating system 336 may include, but are not limited to, LINUX, MAC OSX, BSD, UNIX, MICROSOFT WINDOWS, IOS, ANDROID and the like.

The network 308 comprises one or more communication systems that connect computers by wire, cable, fiber optic and/or wireless link facilitated by various types of well-known network elements, such as hubs, switches, routers, and the like. The network 308 may include an Internet Protocol (IP) network 110, a public switched telephone network (PSTN) 130, or other mobile communication networks, and may employ various well-known protocols to communicate information amongst the network resources.

When a user of user device 202 chooses to fix a poll in a messaging conversation, the user uses the poll creation module 320 to provide polling options and an expiration time indicating how much time participants have to vote. Specifically, once the user creates a group, the user may choose to create a poll, for example, by selecting a “vote” button on a group selection screen. A vote screen may open and contain content, such as vote type (yes/no, multiple choice, etc.), a vote name, expiration time, and the like. The user may also select an option to enable participants to add polling options. The poll creation module 320 generates a poll instruction message that includes at least the polling options and expiration time, and instructions to fix the poll to the display 206 of each user device 202, 204 in the messaging conversation. In some embodiments, a new message type, e.g. a vote message, is used to identify that the message includes a poll as well as identifying other information pertaining to the poll. The transmission module 324 sends the message to the service provider server 302. The message may be, for example, an HTTP message. The poll management module 340 adds the poll 344 to the poll database 342. The poll management module 340 stores the polling options 346, participant information 348 for each participant of the messaging conversation, and an expiration time 352 for the poll. The polling system 338 may use a conversation identifier to identify in which messaging conversation the poll is to be fixed. The messaging system 354 transmits the message to a user device 202, 204 of each participant in the identified messaging conversation via, for example a SIP NOTIFY or PUSH message.

The messaging application 210 on each user device 202, 204 parses the message received from the polling system 338 in order to identify the polling options and expiration time for the poll. The messaging application 210 passes the poll options and instructions to the poll control module 322, which then fixes the poll to the display 206. The SIP NOTIFY message triggers the mobile app to get votes from the server. Messages in the messaging conversation scroll off the screen to make room for incoming messages, while the fixed object remains in view.

When a user of each user device 202, 204 votes for one of the polling options or adds a polling option, if enabled, the poll control module 322 transmits a poll instruction message with an applicable instruction; namely to either increment the vote tally of a polling option or add the polling option. The poll management module 340 updates the participant response 350, and/or the polling options 346. If the participant 348 has previously responded, their prior vote is replaced with their current vote. The poll management module 340 calculates vote tallies for each polling option 346 and generates a poll instruction message indicating the polling options 346 and the current vote tallies. The messaging system 354 transmits the updated poll information to each user device 202, 204 in the messaging conversation. The poll control module 322 updates the display 206 with the current poll information. In some embodiments, an icon indicating a vote progress indicator, such as a % of voters who voted for a polling option, and/or a color indicator of the vote status may be displayed.

Participants may continue to vote and/or add polling options until the expiration time. When the poll expires, the poll management module 340 generates a poll instruction message indicating the final polling options and vote tallies for each. The messaging system 354 transmits the message to each user device 202, 204. The poll control module 322 parses and displays the information. In addition, the poll control module 322 displays a means for a user to share the final vote. The final vote may be shared with a group or on a social media website.

Although the embodiments describe a centralized server managing the poll, one skilled in the art can appreciate that the poll management module 340 may be part of the polling module 318 of the user device 202, 204, thereby enabling each user device 202, 204 to manage responses from participants in the messaging conversation.

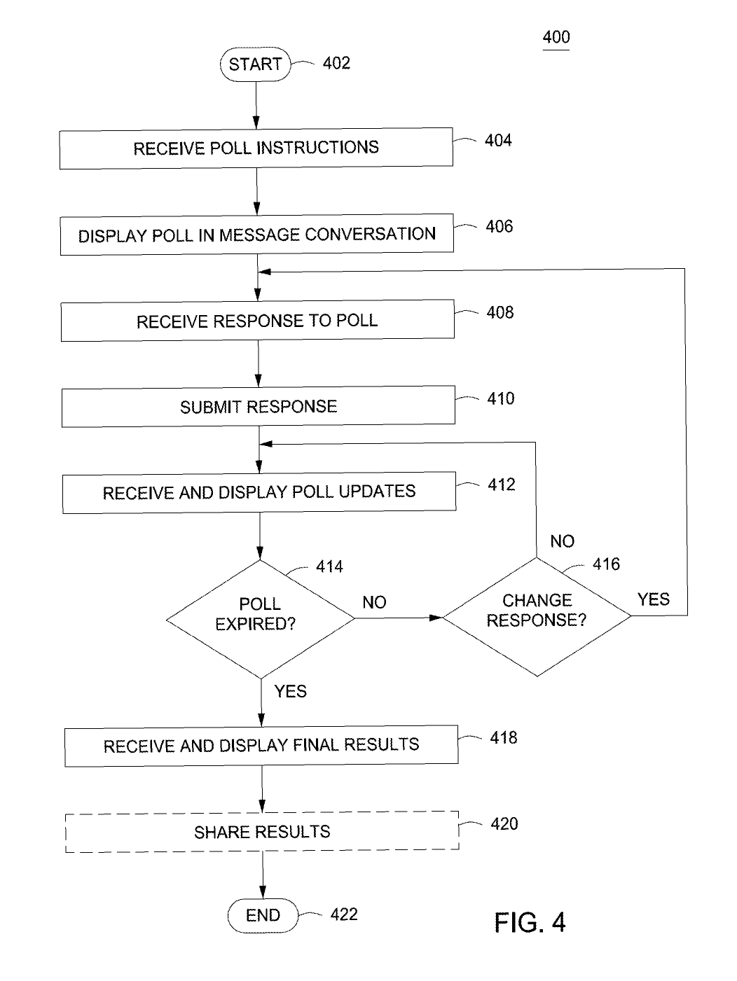

FIG. 4 depicts a flow diagram of a method 400 for controlling polling in message conversations in messaging applications across multiple devices, according to one or more embodiments of the invention. Prior to invoking method 400 a user in a messaging conversation generates a poll and transmits a poll instruction message to a service provider server that forwards the message to each user device in a message conversation. The steps of the method 400 may be implemented in a different order than illustrated by the figure. The method 400 begins at step 402 and proceeds to step 404.

At step 404, poll instructions are received. In some embodiments, the poll instructions are in the form of a new message type, (e.g., a VOTE message) are received in a message from a service provider's server. A messaging conversation is in progress between two or more participants. In some embodiments, a message application, (e.g., messaging application 210) on device 202 displays messages exchanged in an SMS, MMS, or OTT messaging conversation. The messaging conversation may include text messages in addition to other objects, such as a text, an image, a video, or any object that may be transmitted in the messaging conversation. As the messaging conversation progresses, the text messages and other objects scroll off the screen in order to make room to display incoming messages. The poll instructions include two or more polling options and an expiration time. In some embodiments, the poll instructions include an instruction to anchor the poll in the messaging conversation.

At step 406, the poll is anchored in the display of the user device. The display of the user device is partitioned, such that a location of the poll is fixed in a non-scrollable pane of the messaging conversation display screen. The non-scrollable pane of the message conversation display screen holds the anchored poll in view, while a scrollable pane of the message conversation display screen displays incoming and outgoing messages of the messaging conversation. The polling options are displayed in the non-scrollable pane. A countdown timer that indicates the amount of time remaining to respond to the poll is also displayed in the non-scrollable pane.

At step 408, a user response to the poll in received. A user may vote for a polling option. The user may use a finger swipe to select an option, highlight a polling option, or use any method to select the polling option. In some embodiments, in response to a user click within the non-scrollable pane, a menu option is displayed that reads, for example, “add polling option”. The user may then type in a new polling option. If the user wishes to change their response before it is submitted, the user may shake the device. Shaking the device returns the poll to its previous stated before a selection was made. Other gestures may be used for voting. For example, for Yes/No votes, a finger swipe to the left may be interpreted as a Yes vote, while a finger swipe to the right may be interpreted as a No vote.

At step 410, the response is submitted. A poll instruction message that includes the response is transmitted to a service provider server. The message is then forwarded to all user devices participating in the messaging conversation. The response may be an HTTP request such as PUT/POST, a SIP message, and Simple Object Access Protocol (SOAP) message.

At step 412, a poll instruction message is received from the service provider server. The poll instruction message may include the response that the user submitted as well as other responses received from other participants in the messaging conversation. The poll instruction message includes instructions to update the polling options and/or vote tallies based on responses received from participants in the messaging conversation. The message is parsed by the messaging application and the display is updated with the latest poll information. The latest polling options and vote tallies are displayed in the non-scrollable pane.

At step 414, it is determined whether the poll has expired. If the poll has not expired, then responses may continue to be received from other participants or the user may change their response. For example, if another participant has added a polling option, the user may wish to change their vote. In some embodiments, a reminder is displayed at a predefined time before the expiration of the poll, indicating the poll will soon expire. At step 416, if the user wishes to change his or her vote, the method proceeds to step 408, where the user response to the poll is received. If at step 416, the user does not wish to change his or her response, the method continues to receive and display results to the poll until at step 414, it is determined that the poll has expired.

After the poll has expired, at step 418 the final results of the poll are received. The final results are received in a poll instruction message that includes the poll options and final vote tallies. The final vote tallies are displayed as well as an indication that the poll has expired, for example a “Poll Closed” banner in the non-scrollable pane. In some embodiments, a means to share the poll results is displayed on the screen. For example, share buttons for popular social media sites may be displayed. An email link may allow sharing the poll results with a group.

Optionally, at step 420, the poll results are shared using any mechanism displayed in step 418. The method 400 ends at step 422.

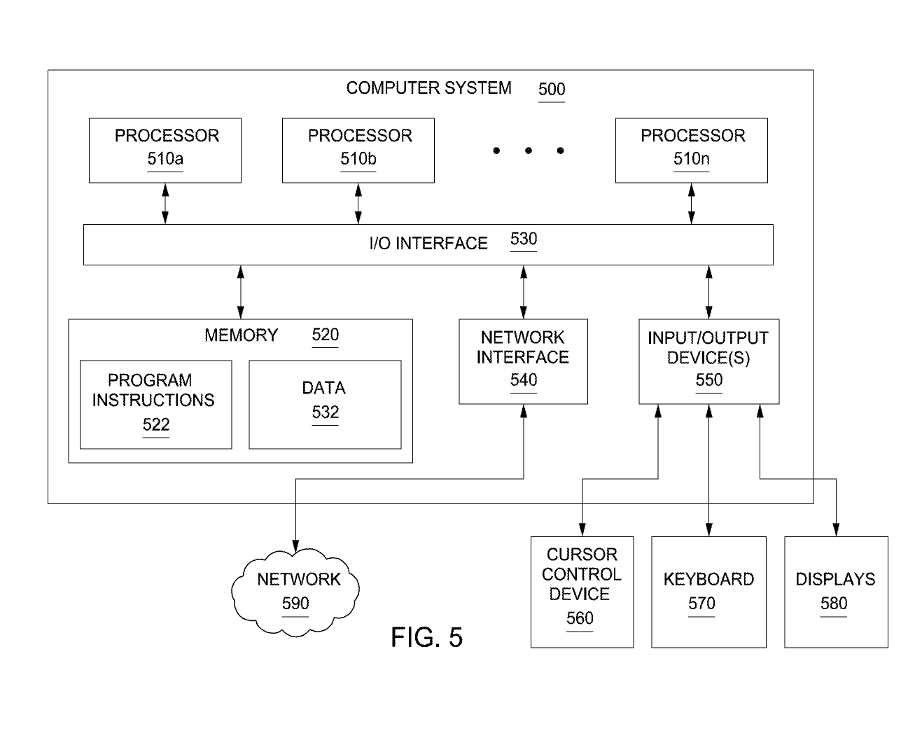

FIG. 5 depicts a computer system 500 that can be utilized in various embodiments of the present invention to implement the computer and/or the display, according to one or more embodiments.

Various embodiments of method and apparatus for organizing, displaying and accessing contacts in a contact list, as described herein, may be executed on one or more computer systems, which may interact with various other devices. One such computer system is computer system 500 illustrated by FIG. 5, which may in various embodiments implement any of the elements or functionality illustrated in FIGS. 1-4. In various embodiments, computer system 500 may be configured to implement methods described above. The computer system 500 may be used to implement any other system, device, element, functionality or method of the above-described embodiments. In the illustrated embodiments, computer system 500 may be configured to implement the method 400 as processor-executable executable program instructions 522 (e.g., program instructions executable by processor(s) 510) in various embodiments.

In the illustrated embodiment, computer system 500 includes one or more processors 510a-510n coupled to a system memory 520 via an input/output (I/O) interface 530. Computer system 500 further includes a network interface 540 coupled to I/O interface 530, and one or more input/output devices 550, such as cursor control device 560, keyboard 570, and display(s) 580. In various embodiments, any of the components may be utilized by the system to receive user input described above. In various embodiments, a user interface may be generated and displayed on display 580. In some cases, it is contemplated that embodiments may be implemented using a single instance of computer system 500, while in other embodiments multiple such systems, or multiple nodes making up computer system 500, may be configured to host different portions or instances of various embodiments. For example, in one embodiment some elements may be implemented via one or more nodes of computer system 500 that are distinct from those nodes implementing other elements. In another example, multiple nodes may implement computer system 500 in a distributed manner.

In different embodiments, computer system 500 may be any of various types of devices, including, but not limited to, a personal computer system, desktop computer, laptop, notebook, or netbook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In various embodiments, computer system 500 may be a uniprocessor system including one processor 510, or a multiprocessor system including several processors 510 (e.g., two, four, eight, or another suitable number). Processors 510 may be any suitable processor capable of executing instructions. For example, in various embodiments processors 510 may be general-purpose or embedded processors implementing any of a variety of instruction set architectures (ISAs). In multiprocessor systems, each of processors 510 may commonly, but not necessarily, implement the same ISA.

System memory 520 may be configured to store program instructions 522 and/or data 532 accessible by processor 510. In various embodiments, system memory 520 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the embodiments described above may be stored within system memory 520. In other embodiments, program instructions and/or data may be received, sent or stored upon different types of computer-accessible media or on similar media separate from system memory 520 or computer system 500.

In one embodiment, I/O interface 530 may be configured to coordinate I/O traffic between processor 510, system memory 520, and any peripheral devices in the device, including network interface 540 or other peripheral interfaces, such as input/output devices 550. In some embodiments, I/O interface 530 may perform any necessary protocol, timing or other data transformations to convert data signals from one component (e.g., system memory 520) into a format suitable for use by another component (e.g., processor 510). In some embodiments, I/O interface 530 may include support for devices attached through various types of peripheral buses, such as a variant of the Peripheral Component Interconnect (PCI) bus standard or the Universal Serial Bus (USB) standard, for example. In some embodiments, the function of I/O interface 530 may be split into two or more separate components, such as a north bridge and a south bridge, for example. Also, in some embodiments some or all of the functionality of I/O interface 530, such as an interface to system memory 520, may be incorporated directly into processor 510.

Network interface 540 may be configured to allow data to be exchanged between computer system 500 and other devices attached to a network (e.g., network 590), such as one or more external systems or between nodes of computer system 500. In various embodiments, network 590 may include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 540 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 550 may, in some embodiments, include one or more display terminals, keyboards, keypads, touchpads, scanning devices, voice or optical recognition devices, or any other devices suitable for entering or accessing data by one or more computer systems 500. Multiple input/output devices 550 may be present in computer system 500 or may be distributed on various nodes of computer system 500. In some embodiments, similar input/output devices may be separate from computer system 500 and may interact with one or more nodes of computer system 500 through a wired or wireless connection, such as over network interface 540.

In some embodiments, the illustrated computer system may implement any of the operations and methods described above, such as the operations described with respect to FIG. 3 and the methods illustrated by the flowchart of FIG. 4. In other embodiments, different elements and data may be included.

Those skilled in the art will appreciate that computer system 500 is merely illustrative and is not intended to limit the scope of embodiments. In particular, the computer system and devices may include any combination of hardware or software that can perform the indicated functions of various embodiments, including computers, network devices, Internet appliances, PDAs, wireless phones, pagers, and the like. Computer system 500 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 500 may be transmitted to computer system 500 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium or via a communication medium. In general, a computer-accessible medium may include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

1. A computer-implemented method for controlling polling in message conversations across multiple devices, comprising:
displaying a poll in a messaging conversation display screen on a first participant device, wherein the poll comprises at least two polling options;
receiving an instruction to update the poll based on a response to the poll from at least one of the multiple devices; and
updating the poll per the received instruction.

2. The method of claim 1, wherein displaying the poll comprises:
partitioning the display screen of a messaging conversation into a scrollable area and a non-scrollable area; and
fixing the poll to the non-scrollable area of the display screen.

3. The method of claim 2, further comprising displaying a timer to indicate an expiration time for the poll.

4. The method of claim 1, wherein the response from the at least one of the multiple devices is a vote for one of the polling options.

5. The method of claim 1, wherein the response from the at least one of the multiple devices is an additional polling option to be added to the poll.

6. The method of claim 1, wherein updating the poll comprises:
displaying the at least two polling options; and
displaying a current vote tally for each of the at least two polling options.

7. The method of claim 1, further comprising:
displaying a menu of possible responses to the poll;
receiving a response to the poll, the response comprising one of a vote for one of the at least two polling options or an additional polling option to add to the poll; and
transmitting the response for display on the multiple devices; and
updating the poll to reflect the response.

8. The method of claim 1, further comprising:
displaying a final vote tally for each polling option after a time to respond to the poll expires; and
transmitting results of the poll to a social media website.

9. A system for controlling polling in message conversations across multiple devices, comprising:
a messaging application comprising a polling module configured to:
display a poll in a messaging conversation display screen on a first participant device, wherein the poll comprises at least two polling options;
receive an instruction to update the poll based on a response to the poll from at least one of the multiple devices; and
update the poll per the received instruction.

10. The system of claim 9, wherein the polling module is configured to display the poll by:
partitioning the display screen of a messaging conversation into a scrollable area and a non-scrollable area; and
fixing the poll to the non-scrollable area of the display screen.

11. The system of claim 10, wherein the polling module is further configured to display a timer to indicate an expiration time for the poll.

12. The system of claim 9, wherein the response from the at least one of the multiple devices is a vote for one of the polling options.

13. The system of claim 9, wherein the response from the at least one of the multiple devices is an additional polling option to be added to the poll.

14. The system of claim 9, wherein the polling module is configured to update the poll by:
displaying the at least two polling options; and
displaying a current vote tally for each of the at least two polling options.

15. The system of claim 9, wherein the polling module is further configured to:
display a menu of possible responses to the poll;
receive a response to the poll, the response comprising one of a vote for one of the at least two polling options or an additional polling option to add to the poll; and
transmit the response for display on the multiple devices; and
update the display of the poll to reflect the response.

16. The system of claim 9, wherein the polling module is further configured to:
display a final vote tally for each polling option after a time to respond to the poll expires; and
transmitting results of the poll on a social media website.

17. A non-transitory computer readable medium for controlling polling in message conversations across multiple devices, comprising:
displaying a poll in a messaging conversation display screen on a first participant device, wherein the poll comprises at least two polling options;
receiving an instruction to update the poll based on a response to the poll from at least one of the multiple devices; and
updating the poll per the received instruction.

18. The computer readable medium of claim 17, wherein displaying the poll comprises:
partitioning the display screen of a messaging conversation into a scrollable area and a non-scrollable area; and
fixing the poll to the non-scrollable area of the display screen.

19. The computer readable medium of claim 18, further comprising displaying a timer to indicate an expiration time for the poll.

20. The computer readable medium of claim 17, wherein the response from the at least one of the multiple devices is one of a vote for one of the polling options or an additional polling option to be added to the poll.

21. The computer readable medium of claim 17, further comprising:
displaying a final vote tally for each polling option after a time to respond to the poll expires; and
transmitting results of the poll to a social media website.
